(19) United States
(12) Patent Application Publication
(10) Pub. No.: US 2012/0036727 A1
(43) Pub. Date: Feb. 16, 2012

(54) LASER-TRANSPARENT TAPE MEASURE

(76) Inventor: Ronald J. McCarthy, Charlestown, WV (US)

(21) Appl. No.: 13/016,477

(22) Filed: Jan. 28, 2011

Related U.S. Application Data
(60) Provisional application No. 61/299,057, filed on Jan. 28, 2010.

(51) Int. Cl. G01B 3/10

(52) U.S. Cl. 33/760

(57) ABSTRACT

A tape measure having an integral pencil sharpener specifically for square contractor pencils, and a retractable tape formed with opposing indexed metal edges flanking a central elongate transparent or translucent window for allowing a laser beam to shine centrally through.

### CROSS REFERENCE TO RELATED APPLICATIONS

This application derives priority from U.S. provisional application Ser. No. 61/299,057 filed 28 Jan. 2010, which is hereby incorporated by reference as if fully set forth herein.

### BACKGROUND OF THE INVENTION

1. Field of the Invention

The present invention relates to hand tools and, more particularly, to a laser-transparent measuring tape useful in combination with a laser for making precise measurements on construction projects.

2. Discussion of the Related Art

A plumb-bob or a plummet is a weight that is suspended from a string and used as a vertical reference line, or plumb-line. The plumb bob was used by the early Egyptians to ensure that constructions are “plumb”, or vertical. Tape measures are comparatively newer and yet more ubiquitous instruments. Tape measures typically comprise a coiled cloth or metal strip with linear-measurement markings. The flexibility allows for a measure of significant length to be easily carried in one's pocket or tool box, and it also permits measurement around curves or corners. A plumb-bob can be used with a tape measure to transcribe architectural measurements into markings on the work surfaces.

Lasers are largely replacing plumb bobs in the construction trade. The three most common types of laser levels are Rotary Laser Levels, Line Laser Levels (or Line Generators) and Dot Laser Levels (or Multi-Point Lasers). The dot lasers emit one or more laser beams to produce solid dots on the work surface. The dots are reference marks, and can likewise be used to ensure that something is “plumb” or level.

For example, to erect a support pole in a pole barn, a worker need only place the dot laser on the ground next to a post, climb up to the top with a tape measure and measure over to the laser beam. The result is usually more accurate than the ancient plumb bob which is susceptible to blowing in the wind. However, with a standard measuring tape, the worker often needs to see underneath the tape to view the laser dot.

It would be far more advantageous to provide a tape measure with retractable tape that allows partial transmission of a laser beam there through, so that a laser beam shining on one side of the tape will appear as a dot on the other side of the tape. This would allow a worker to see the laser through the tape.

The general concept of transparent rulers having grid lines is known from drafting instruments. For example, U.S. Pat. No. D522,889 to Wallace issued Jun. 13, 2006 shows an ornamental transparent measuring tape.

U.S. Pat. No. 304,245 to Thomas issued August 1884 shows a transparent ruler.

Similarly, U.S. Pat. No. 5,819,422 to Schafer issued Oct. 13, 1998 shows a transparent drafting and measuring device.

However, these instruments are intended for measuring atop architectural drawings, and not for displaying a laser dot. None suggest a tape measure design adapted for laser pass-through, and none address the problem of making an extended coil of tape translucent while still preserving its flexibility, durability and wear-resistance.

### SUMMARY OF THE INVENTION

Accordingly, it is an object of the present invention to provide tape measure having a translucent window adapted for use with a dot laser and having a predetermined return loss (difference between power incident upon the tape and the power reflected from the tape) so that a laser beam shining on one side of the tape will appear as a dot in the window on the other side of the tape, thereby allowing a worker to see the laser through the tape.

It is another object to provide a tape measure with the foregoing qualities that is also flexible, durable and wear-resistant.

It is another object to provide a laser-translucent tape measure as described above with integral tape cleaner for cleaning the translucent window.

It is another object to provide a laser-translucent tape measure as described above with slidable index clip mounted on the tape for more accurate measurement and for marking measurements.

It is another object to provide a laser-translucent tape measure as described above with integral pencil and holder for marking measurements.

It is still another object to provide a laser-translucent tape measure as described above with integral pencil sharpener for sharpening said pencil.

In accordance with the foregoing objects, the present invention is a laser-translucent tape measure having a translucent window running lengthwise along the tape, and having a predetermined return loss so that a laser beam shining on one side of the tape will appear as a dot in the window on the other side of the tape, thereby allowing a worker to see the laser through the tape. In a preferred embodiment a split-tape is provided having opposing metal edges marked with measuring indicia, and a central translucent window between said edges. This construction preserves the flexibility, durability and wear-resistance needed for construction-grade tape measures. The laser-translucent tape disclosed herein is flexible and coiled onto a spring-biased bobbin inside a portable housing. It is withdrawn through a slot in the housing, and the slot/housing is equipped with an integral wiper for wiping the tape clean after use, and for preventing entry of dust and debris. To facilitate its laser application, the tape measure is also provided with a slidable transparent index clip mounted on the tape. The index clip can be moved overtop the dot laser position for more accurate measurement in tight places and for marking measurements. As an added convenience, the laser-translucent tape measure of the present invention is equipped with an integral pencil for marking measurements, pencil holder, and pencil sharpener.

Additional advantages, objects, and features of the invention will be set forth in part in the description which follows and in part will become apparent to those having ordinary skill in the art upon examination of the following or may be learned from practice of the invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of the laser-translucent tape measure 2 according one embodiment of the present invention.

FIG. 2 is a close-up perspective view of the laser-translucent tape measure 2 showing the wiper 16.

FIG. 3 is a close-up perspective view of the laser-translucent tape 10 construction.

FIG. 4 is a close-up perspective view of an alternate laser-translucent tape 100 construction.

FIG. 5 is a top view of the slidable transparent index clip 40.

FIG. 6 is a side view of the slidable transparent index clip 40.

### DETAILED DESCRIPTION OF THE INVENTION

Reference will now be made in detail to preferred embodiments of the present invention, examples of which are illustrated in the accompanying drawings. Wherever possible, the same reference numbers will be used throughout the drawings to refer to the same or like parts. Hereinafter, a laser-translucent tape measure is described which is useful in taking or making measurements when using a construction laser, because the uncoiled tape allows partial transmission of a laser beam there through, so that a laser beam shining on one side of the tape will appear as a dot on the other side of the tape. This allows a worker to see the laser through the tape.

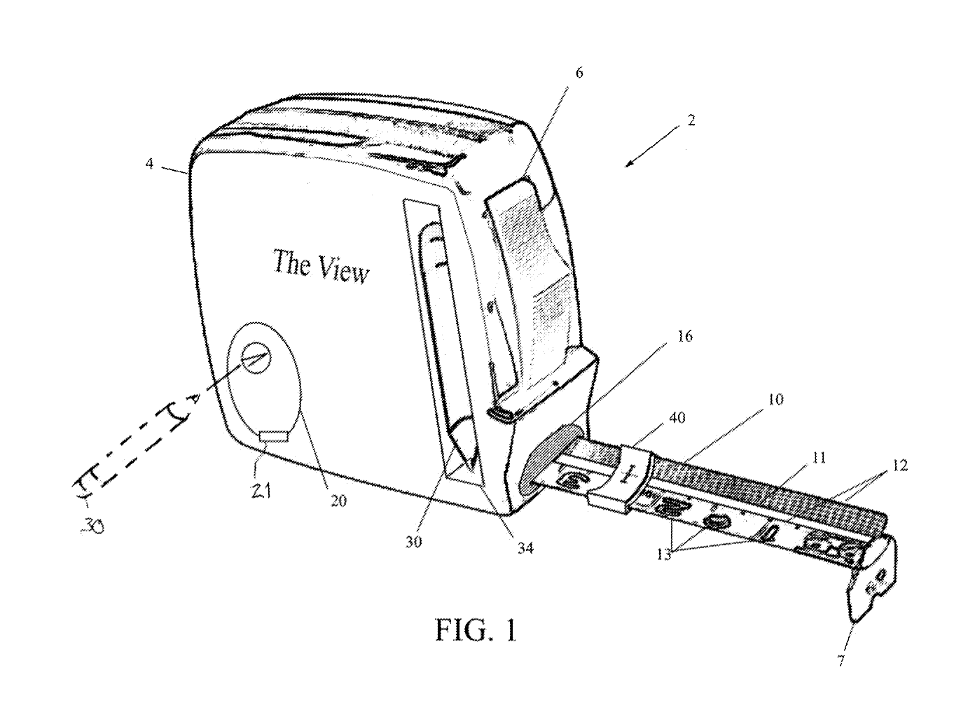

FIG. 1 is a perspective view of the laser-translucent tape measure 2 according one embodiment of the present invention. The tape measure 2 generally includes a partially translucent tape 10 formed as a split tape with opposing opaque margins 12 marked with measuring indicia 13, and an elongate translucent window 11 running lengthwise between the margins 12 along the entire length of the tape 10. The margins 12 may be conventional resilient metallic strips formed as in conventional tape measures, with a notch (or plural notches) cut lengthwise up the center as will be described. The translucent window 11 is preferably a resilient substantially transparent plastic inlay affixed centrally in the notch(es) between the opaque margins 12 of the tape. The translucent window 11 plastic is preferably slightly colorized or textured to increase the contrast of the laser beam shining thereon, although colorization/texture is optional. Even substantially “transparent” plastic will have an inherent return loss, and a small return loss is all that is needed to ensure that a laser beam shining on one side of the tape will appear as a dot in the window on the other side of the tape, thereby allowing a worker to see the laser through the tape.

The split-tape margins 12 along the length of the tape 10 are laminated with conventional measuring indicia 13 including numbers and gridlines forming an English or metric scale as desired. This split-tape 10 construction preserves the flexibility, durability and wear-resistance needed for construction-grade tape measures. The tape 10 is retractable from a housing 4 in conventional format, and is coiled about a spring-loaded spool contained therein in a conventional manner. A metallic stop-flange 7 is provided at the distal end of tape 10 to prevent over-retraction into the housing 4 and to anchor the extended tape 10 against work surfaces, and a conventional internal locking mechanism with external slide-lock button 6 is provided to lock the tape 10 in an extended position.

The tape 10 enters the housing 4 through an aperture at the side bottom, and in accordance with the present invention the aperture is fitted with a slotted grommet 16 through which the tape 10 passes during retraction/extension. The slotted grommet 16 may be formed of rubber, Mylar™ or other synthetic sheet, and wipes the tape 10, serving to keep the translucent window 11 clean as well as to prevent dust and debris from entering the housing 4.

To further facilitate its use with a dot laser, the tape measure 2 is provided with a slidable transparent index clip 40 mounted on the tape 10. The index clip 40 can be moved left or right overtop the dot laser position on window 11 for more accurate measurement in tight places and for marking and retaining measurements for a time.

As an added convenience, the laser-translucent tape measure of the present invention is equipped with an integral pencil 30 for marking measurements, pencil 30 friction-fitting within a molded alcove 34 in the side of the housing 4 that serves as a flush pencil holder. In addition, a pencil sharpener cartridge 20 is releasably loaded into a receptacle in the housing 4 for convenient sharpening of pencil 30.

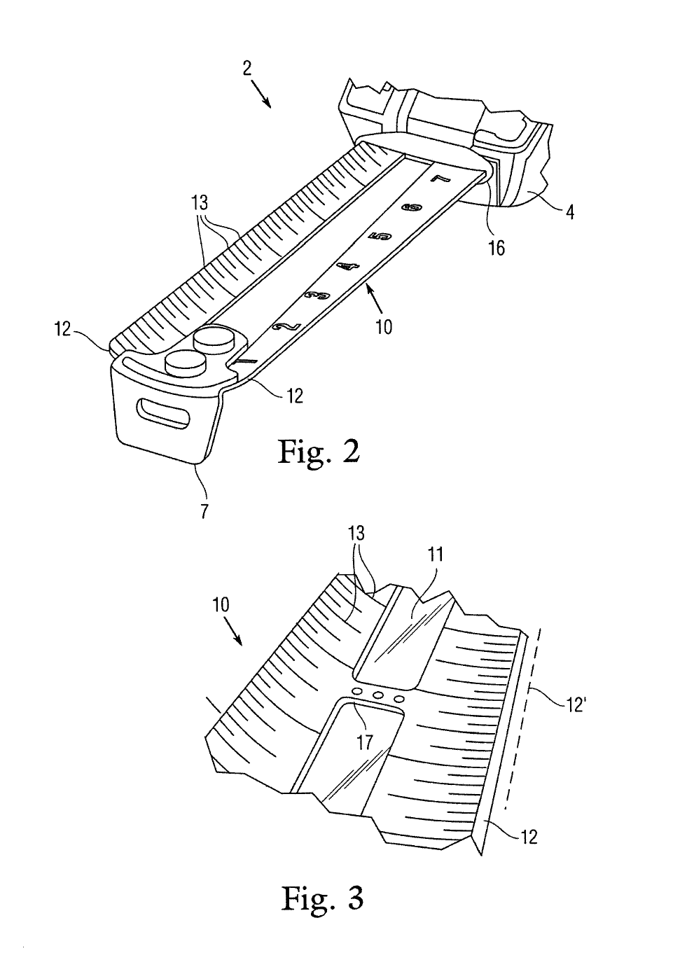

FIG. 2 is a close-up perspective view of the laser-translucent tape measure 2 showing the slotted grommet wiper 16 at the tape aperture in housing 4. The slotted grommet 16 may be held captive in the walls of housing 4 by a tongue-and-groove fit, and includes a transverse central slit through which the tape 10 passes inwardly. The resilient lips of the grommet wiper 16 surrounding the central slit abut the surfaces of the tape 10, particularly window 11, and wipe it clean during extension/retraction, thereby ensuring a clean viewing surface and as well sealing the housing 4 against dust and debris. One skilled in the art will readily understand that an inwardly-bristled brush-like O-ring would also suffice.

FIG. 3 is a close-up perspective view of an exemplary laser-translucent tape 10 construction. The translucent tape 10 is herein formed as a split tape with opposing resilient metal margins 12 marked with the measuring indicia 13. The elongate translucent window 11 runs lengthwise between the margins 12 along substantially the entire length of the tape 10. The translucent window 11 may be affixed between the margins 12 as illustrated by bridging the groove between the margins at evenly-spaced intervals with cross-connectors 17, and riveting or otherwise adhering the plastic strip of translucent window 11 to the cross-connectors 17, so that the plastic strip of translucent window 11 is fixedly attached directly beneath the margins 12.

Alternatively or additionally, as seen in dotted lines in FIG. 3, the margins 12 may be formed as two substantially identical overlying layers 12-12′, effectively sandwiching the translucent window 11 there between. In this latter case the two-ply margins 12-12′ may be welded together peripherally and/or at cross-connectors 17 as shown. In this latter case the two-ply margins 12-12′ may be welded together peripherally and/or at cross-connectors 17 as shown. In all such cases the notch (or plural notches) as well as cross-connectors 17 if used) may be cut or stamped lengthwise up the center of tape 10 and the translucent window 11 affixed over the notch by any suitable means.

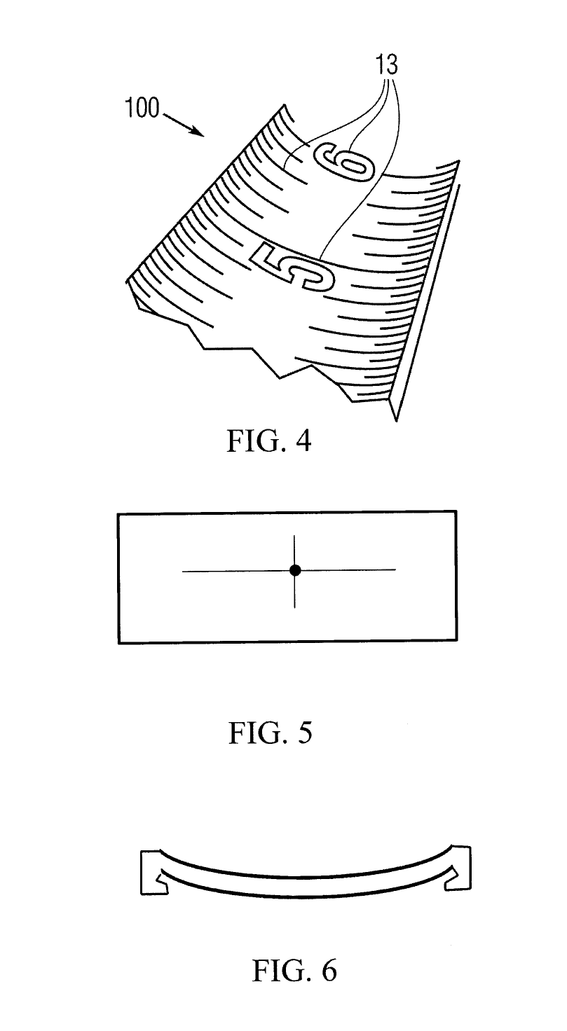

Still another embodiment of tape 100 is shown in FIG. 4. In this embodiment, the entire tape 100 is formed as translucent resilient material such as semi-rigid vinyl, polycarbonate or cellulose propionate formed by extrusion molding. The entire tape 100 may be tinted or textured to increase laser contrast, and conventional measuring indicia 13 including numbers and gridlines forming an English or metric scale may be imprinted thereon during extrusion as desired.

FIGS. 5 and 6 are a top view and side view, respectively, of the slidable transparent index clip 40. The slidable transparent index clip 40 comprises a slightly convex transparent rectangular plastic member sized to span the tape 10, and having peripheral flanges 47 that wrap around the edges of tape 10 gripping it there beneath. This tongue-in-groove fit leaves the clip freely slidable, subject to friction, along the entire length of the tape 10. The major surface of the clip 40 is imprinted or ingrained with cross-hairs 43 converging to a central dot 45. This way, when a user makes a measurement with the tape 10 using a laser dot as a reference, the user can slide the clip 40 along the tape 10 until the laser dot is sighted in the cross-hairs 43 and/or dot 45. This capability helps to increase the accuracy of measurements and also provides a temporary bookmark of each measurement which is especially helpful in tight or awkward locations.

Referring back to FIG. 1, the integral pencil 30 is an additional convenience useful for marking measurements, and in the preferred embodiment the pencil 30 is removably friction-fit within a molded alcove 34 in the side of the housing 4 that serves as a flush pencil holder. This type of mounting keeps the pencil out of the way, recessed flush within the housing, and protects it when not in use. However, one skilled in the art will readily appreciate that the pencil 30 may be attached exterior to the housing 4 by other means, such as hook and loop pads or a resilient clip protruding from housing 4. The presence of pencil 30 facilitates transfer of each measurement from tape 10 to clip 40 to notebook.

The pencil sharpener 20 for sharpening pencil 30 is preferably a small cartridge insert that may be inserted into a conforming aperture/receptacle in housing 4, and held therein by an exterior detent lock 21 similar to those used in battery compartment covers. The pencil sharpener 20 cartridge preferably includes an on-board reservoir for the shavings, which reservoir may be emptied by removal of the cartridge 20.

In use of the laser-translucent tape measure 2 to, for example, install a ceiling bracket over a spot on the floor by measuring a plumb between two ceiling rafters, the red dot laser is placed on the floor and the laser is directed upward to the ceiling. The tape 10 of tape measure 2 is extracted and laid between rafters to measure over to the laser beam. The red dot laser is brightly visible within window 11 from overtop the tape. The user can then slide clip 40 to coincide, disembark the ladder, retrieve the measurement position of clip 40 and write in down using pencil 30. The entire process is greatly simplified.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A tape measure for use in conjunction with a laser, comprising:
a compact housing;
an elongate resilient tape coiled on a spring-loaded spool rotatably seated in said housing, said tape being marked with measurement indicia along substantially its entire length for measuring incidence of a laser beam thereon, said tape being further defined by at least one elongate notch extending medially and lengthwise along said tape, and an elongate resilient plastic strip attached lengthwise along said tape and spanning said notch along its entire length for displaying said incident laser beam on a side of said tape opposite the side on which said laser beam is incident.

2. The tape measure for use in conjunction with a laser according to claim 1, wherein said plastic strip is substantially transparent.

3. The tape measure for use in conjunction with a laser according to claim 1, wherein said plastic strip is translucent.

4. The tape measure for use in conjunction with a laser according to claim 3, wherein said translucent plastic strip is colorized.

5. The tape measure for use in conjunction with a laser according to claim 3, wherein said translucent plastic strip is textured

6. The tape measure for use in conjunction with a laser according to claim 1, wherein said elongate resilient tape further comprises opposing resilient metal strips both defined by a lengthwise notch, said plastic strip being sandwiched between said overlying resilient metal strip.

7. The tape measure for use in conjunction with a laser according to claim 1, wherein said elongate resilient tape is defined by a plurality of evenly-spaced elongate notches extending medially and lengthwise along said tape and defined by cross-connectors separating adjacent notches, said elongate resilient plastic strip being affixed to each of said cross-connectors.

8. The tape measure for use in conjunction with a laser according to claim 1, further comprising a substantially transparent plastic clip slidably mounted on said tape.

9. The tape measure for use in conjunction with a laser according to claim 8, wherein said transparent plastic clip comprises opposing end-flanges for gripping said tape.

10. The tape measure for use in conjunction with a laser according to claim 9, wherein said transparent plastic clip is defined by cross-hairs.

11. The tape measure for use in conjunction with a laser according to claim 1, further comprising a pencil removably attached to said housing.

12. The tape measure for use in conjunction with a laser according to claim 11, wherein said housing is defined by an elongate recess for friction-fit insertion of said pencil.

13. The tape measure for use in conjunction with a laser according to claim 11, further comprising a pencil sharpener cartridge removably inserted in a receptacle in said housing.

14. A tape measure for use in conjunction with a laser, comprising:
a compact housing;
an elongate resilient tape coiled on a spring-loaded spool rotatably seated in said housing, said tape being marked with measurement indicia along substantially its entire length for measuring incidence of a laser beam thereon, said tape being substantially transparent for displaying said incident laser beam on a side of said tape opposite the side on which said laser beam is incident.

15. The tape measure for use in conjunction with a laser according to claim 14, wherein said substantially transparent tape is plastic.

16. The tape measure for use in conjunction with a laser according to claim 15, wherein said plastic tape is translucent.

17. The tape measure for use in conjunction with a laser according to claim 16, wherein said translucent plastic tape is colorized.

18. The tape measure for use in conjunction with a laser according to claim 16, wherein said translucent plastic tape is textured.

19. The tape measure for use in conjunction with a laser according to claim 14, further comprising a substantially transparent plastic clip slidably mounted on said tape.

20. The tape measure for use in conjunction with a laser according to claim 19, wherein said transparent plastic clip comprises opposing end-flanges for gripping said tape.

21. The tape measure for use in conjunction with a laser according to claim 20, wherein said transparent plastic clip is defined by cross-hairs.

22. The tape measure for use in conjunction with a laser according to claim 14, further comprising a pencil removably attached to said housing.

23. The tape measure for use in conjunction with a laser according to claim 22, wherein said housing is defined by an elongate recess for friction-fit insertion of said pencil.

24. The tape measure for use in conjunction with a laser according to claim 22, further comprising a pencil sharpener cartridge removably inserted in a receptacle in said housing.
